(19) United States
(12) Patent Application Publication
(10) Pub. No.: US 2021/0221391 A1
(43) Pub. Date: Jul. 22, 2021

(54) SYSTEM AND METHOD FOR TESTING COOPERATIVE DRIVING CAPABILITY OF AUTOMATED VEHICLES

(71) Applicant: CHANG'AN UNIVERSITY, Xi'an (CN)

(72) Inventors: Xiangmo ZHAO, Xi'an (CN); Runmin WANG, Xi'an (CN); Zhigang XU, Xi'an (CN); Yu ZHU, Xi'an (CN); Wenshuai ZHOU, Xi'an (CN); Lan YANG, Xi'an (CN); Pengpeng SUN, Xi'an (CN); Zhanwen LIU, Xi'an (CN); Haigen MIN, Xi'an (CN)

(21) Appl. No.: 17/134,394

(22) Filed: Dec. 26, 2020

(30) Foreign Application Priority Data
Jan. 22, 2020 (CN) 202010075281.2

(51) Int. Cl. B60W 50/04; B60W 60/00; B60W 40/105; H04W 4/40

(52) U.S. Cl. CPC B60W 50/045; B60W 60/00186; B60W 40/105; B60W 2420/42; B60W 2554/804; B60W 2050/046; B60W 2556/45; H04W 4/40

(57) ABSTRACT

Provided herein relates to the performance testing of automated vehicles, and more particularly to a system and a method for testing cooperative driving capability of an automated vehicle. The system includes a target vehicle, a test road and a control center, where the automated vehicle and the target vehicle are located on the test road, and the control center is located beside the test road. A speed sensor and a binocular camera are provided on the automated vehicle. The speed sensor and the binocular camera are connected to the control center through a wireless communication device, respectively. An on-board device is provided on the target vehicle and is connected to the control center through the wireless communication device. The method provided herein is used to determine the responsiveness of automated vehicles according to the speed relationship and distance between the automated vehicle and the target vehicle.

### CROSS-REFERENCE TO RELATED APPLICATIONS

This application claims the benefit of priority from Chinese Patent Application No. 202010075281.2, filed on Jan. 22, 2020. The content of the aforementioned application, including any intervening amendments thereto, is incorporated herein by reference in its entirety.

### TECHNICAL FIELD

This disclosure relates to the performance testing of automated vehicles, and more particularly to a system and a method for testing cooperative driving capability of automated vehicles.

### BACKGROUND

The development of society and economy brings higher requirement for life quality, and in this case, automated vehicles are developed and gradually used in our daily life. The popularization of automated vehicles further changes the way to travel and affects the global economy. Therefore, it is of great significance to design a scientific and perfect test and evaluation system to improve the research and development efficiency of automated vehicles, perfect technical standards and laws and regulations, and promote the innovation and development of related industries. Before tested on a public road, the automated vehicles are required to experience a large number of repeatable tests at different levels in a controllable real scenario to ensure the safety of the autonomous vehicle's own functions and the reliability of the system, so as to promote the innovation and development of technology and protect public safety.

The cooperative driving of automated vehicles is a driving method which renders the driving of the vehicles having the same or related driving route more efficient and the utilization rate of the road higher by means of the perception and decision-making performance of the automated vehicles. However, the test of the automated vehicles' cooperative driving is relatively dangerous and complicated due to the presence of other traffic participants. Tests for the cooperative driving of automated vehicles are of great significance for ensuring the safe operation of automated vehicles and testing the driving capability of automated vehicles. However, there is currently a lack of a test method and a test system close to the real road scenario, and it is impossible to accurately obtain the actual traffic operation status of the automated vehicles merely based on the simulation of the operating scenario to optimize the operation task. Therefore, there is an urgent need to develop a system and method capable of testing the cooperative driving capability of automated vehicles in an approximately real road scenario.

### SUMMARY

An object of this application is to provide a system and a method for testing cooperative driving capability of automated vehicles to overcome the defects in the prior art that the cooperative driving scenario of automated vehicles has high risk and is difficult to reproduce; there are great difficulty in recording data and operating the test method; the test cost is relatively high. The system provided herein has a simple structure, and can determine the responsiveness of the automated vehicles based on the speed relationship and the distance information between the automated vehicle and the target vehicle, completing the test of the cooperative driving capability of the automated vehicles at a high efficiency and a low cost.

The technical solutions of this application are described as follows.

In a first aspect, this application provides a system for testing cooperative driving capability of an automated vehicle, comprising:

the automated vehicle;

a target vehicle;

a test road; and

a control center;

wherein the automated vehicle and the target vehicle are located on the test road, and the control center is located beside the test road;

a speed sensor and a binocular camera are provided on the automated vehicle; and the speed sensor and the binocular camera are connected to the control center through a wireless communication device, respectively;

the target vehicle is a simulation vehicle for testing, and an on-board device is provided on the target vehicle; the on-board device is connected to the control center through the wireless communication device.

In some embodiments, the speed sensor is configured to obtain a speed of the automated vehicle and transmit the speed of the automated vehicle to the control center;

the binocular camera is configured to acquire a distance between the automated vehicle and the target vehicle and a motion video of the target vehicle, and transmit the distance between the automated vehicle and the target vehicle and the motion video of the target vehicle to the control center; and

the on-board device is configured to obtain a speed of the target vehicle and transmit the speed of the target vehicle to the control center.

In some embodiments, the control center is configured to receive the speed of the automated vehicle, the distance between the automated vehicle and the target vehicle, the motion video of the target vehicle, and the speed of the target vehicle, determine a cooperative driving capability of the automated vehicle and send driving instructions to the automated vehicle and the target vehicle.

In some embodiments, the wireless communication device has a V2X communication protocol.

In some embodiments, the system further comprises a safety officer; the safety officer is configured to drive the automated vehicle to a starting point of the test road in manual driving mode, and then switch the manual driving mode to automatic driving mode after the automated vehicle is stopped, and the safety officer is further configured to send driving instructions to the target vehicle through the control center.

In a second aspect, this application provides a method for testing cooperative driving capability of an automated vehicle, comprising:

(1) driving, by a safety officer, an automated vehicle to a starting point of a test road in manual driving mode, and parking the automated vehicle;

(2) controlling, by a control center, a target vehicle to travel to a position in front of the automated vehicle in the same lane, wherein the position is away from the automated vehicle at a safe distance;

(3) sending, by the safety officer, a test request to the control center; sending, by the control center, a driving instruction to the automated vehicle according to the received test request; starting, by the safety officer, an automatic driving mode of the automated vehicle according to the driving instruction received by the automated vehicle; and at the same time, controlling, by the control center, the target vehicle to travel at a preset speed and route;

(4) obtaining, by a speed sensor on the automated vehicle, a speed of the automated vehicle in real time, and transmitting, by the wireless communication device, the obtained speed of the automated vehicle to the control center;

obtaining, by a binocular camera, a distance between the automated vehicle and the target vehicle and a motion video of the target vehicle in real time, and transmitting, by the wireless communication device, the distance between the automated vehicle and the target vehicle and the motion video of the target vehicle to the control center;

obtaining, by an on-board device on the target vehicle, a speed of the target vehicle in real time; and transmitting, by the wireless communication device, the speed of the target vehicle to the control center; and

(5) determining, by the control center, the cooperative driving capability of the automated vehicle according to the speed of the automated vehicle, the distance between the automated vehicle and the target vehicle and the speed of the target vehicle.

In some embodiments, in step (2), the safe distance is 50 m.

In some embodiments, in step (5), the cooperative driving capability of the automated vehicle is determined as follows:

if the distance between the automated vehicle and the target vehicle is greater than or equal to a preset following distance, and a difference between the speed of the automated vehicle and the speed of the target vehicle is within an error range, the cooperative driving capability of the automated vehicle is considered qualified; otherwise, unqualified.

In some embodiments, the preset following distance is 10 m, and the error range is from −5 to 5 km/h.

Compared to the prior art, this application has the following beneficial effects.

(1) In the system provided herein, the target vehicle is remotely controlled to travel on the test road in the predetermined test route, and the responsiveness of the automated vehicle is analyzed through the speed sensor and the binocular camera arranged thereon. Compared to the virtual simulation test, this application has more realistic driving and traffic scenario, and thus the test results are more realistic and reliable. Furthermore, compared to the actual test, this application has a safer and repeatable test process, and a lower cost.

(2) The automated vehicle enters the predetermined test scenario according to the predetermined test task. The tester can remotely control the running speed and trajectory of the target vehicle in real time, and obtain the data of the automated vehicle (including the speed of the automated vehicle, and the distance between the automated vehicle and the target vehicle) through the speed sensor and the binocular camera arranged on the automated vehicle, and the speed of the target vehicle through the on-board device of the target vehicle. The control center can determine the responsiveness of the automated vehicle according to the speed relationship and the distance information between the automated vehicle and the target vehicle, and then complete the test of the cooperative driving capability of the automated vehicle. The actual operating data is considered, and the test scenario is closer to the real road conditions of the automated vehicles, so that this application is suitable for the test of various automated vehicles. Given the above, this application can provide more reliable test results, improve the test efficiency of the cooperative driving capability of the automated vehicles, and provide a reference for optimizing the cooperative driving of the automated vehicles.

(3) By using the speed sensor and binocular camera arranged on the automated vehicle to obtain the data in real time, the problem of inaccurate test of the cooperative driving performance of automated vehicles caused by the failure of the speed-measuring device and the distance-measuring device can be avoided, which makes the test results more accurate and reliable.

### BRIEF DESCRIPTION OF THE DRAWINGS

This application will be further described in detail below with reference to the accompanying drawings and embodiments.

FIG. 1 schematically shows a test scenario of following behavior of an automated vehicle on straight roads (including deceleration of and emergency braking of the vehicle ahead).

FIG. 2 schematically shows a test scenario where a vehicle ahead in the adjacent lane drives into the lane of the automated vehicle when the automated vehicle is travelling on a straight road.

FIG. 3 schematically shows a test scenario where an automated vehicle is following a vehicle on a straight road, and the vehicle ahead drives out of the lane of the automated vehicle.

FIG. 4 schematically shows a test scenario where an automated vehicle is overtaking the leading vehicle on a straight road.

In the drawings, V1, automated vehicle; V2, target vehicle; Z1, control center; B1, first lane; B2, second lane; L1, starting point; and L2, end point.

### DETAILED DESCRIPTION OF EMBODIMENTS

The technical solutions of the invention will be further described below in detail with reference to the embodiments. It should be understood by those skilled in the art that these embodiments are merely illustrative of the disclosure, and are not intended to limit the scope of the disclosure.

This disclosure provides a system for testing cooperative driving capability of an automated vehicle, including: the automated vehicle, a target vehicle, a road, a control center and a safety officer.

The road is a straight road with two lanes in the same direction, and each lane has a width of 3.5 m. Two solid lines are provided on both sides of the lanes and a dotted line is provided between the two lanes.

A speed sensor and a binocular camera are provided on the automated vehicle, and the speed sensor is connected to the control center through a wireless communication device, and the binocular camera is connected to the control center through a wireless communication device with a V2X communication protocol. The speed sensor is configured to obtain a speed of the automated vehicle, and transmit the speed of the automated vehicle to the control center. The binocular camera is configured to acquire a distance between the automated vehicle and the target vehicle and a motion video of the target vehicle, and transmit the distance between the automated vehicle and the target vehicle and the motion video of the target vehicle to the control center.

The target vehicle is a special mobile platform equipped with a simulation vehicle for testing. The target vehicle is provided with an on-board device, which is connected to the control center through a wireless communication device. The wireless communication device has a V2X communication protocol. The on-board device is configured to obtain a speed of the target vehicle and transmit the speed of the target vehicle to the control center.

The control center includes a wireless communication device with a V2X communication protocol, and is configured to receive the speed of the automated vehicle, the distance between the automated vehicle and the target vehicle, the motion video of the target vehicle, and the speed of the target vehicle, to determine a cooperative driving capability of the automated vehicle, and send driving instructions to the automated vehicle and the target vehicle.

The safety officer is configured to drive the automated vehicle to a starting point of the road in manual driving mode, and then switch the manual driving mode to automatic driving mode after the automated vehicle is stopped. The safety officer is further configured to send driving instructions to the target vehicle through the control center.

The method provided herein for testing cooperative driving capability of an automated vehicle is described in detail below with reference to the embodiments.

### Embodiment 1

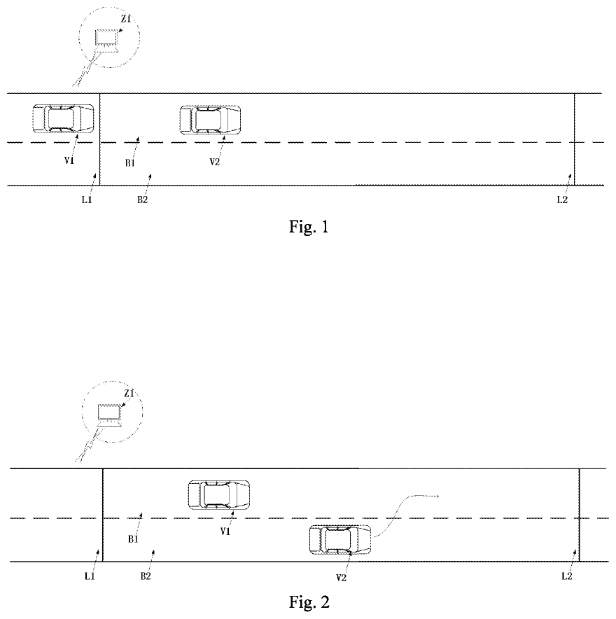

As shown in FIG. 1, the method of this disclosure for testing cooperative driving capability of an automated vehicle is used to test the cooperative following capability of the automated vehicle on a straight road. The road includes at least two straight lanes (a first lane B1 and a second lane B2), and the line between the first lane B1 and the second lane B2 is a dotted line. The automated vehicle is labeled as V1; a target vehicle is labeled as V2; a control center is labeled as Z1; a starting point is labeled as L1; and an end point is labeled as L2. The method is specifically described as follows.

(1) The automated vehicle V1 is driven by the safety officer to the starting point L1 of the first lane B1 in manual driving mode, and parked. A following distance is preset by the control center Z1 to be 10 m.

(2) The target vehicle V2 is controlled by the control center Z1 to travel to a position in front of the automated vehicle V1 in the same lane, where a distance between the position and the automated vehicle V1 is 50 m.

(3) The safety officer sends a test request to the control center Z1, and the control center Z1 sends a driving instruction to the automated vehicle V1 according to the received test request. The safety officer starts an automatic driving mode of the automated vehicle V1 according to the received driving instruction, and the automated vehicle V1 starts from the test starting point and enters the test scenario. The automated vehicle V1 is accelerated to 35 km/h on the first lane B1, and then approaches the target vehicle V2 along the middle of the lane at a constant speed. At the same time, the control center Z1 controls the target vehicle V2 to accelerate to (30±2) km/h (minimum speed for straight travelling) and then travel straightly along the first lane B1.

(a) When the distance between the automated vehicle V1 and the target vehicle V2 reaches the preset following distance, whether the automated vehicle V1 can adjust its speed to stably follow the target vehicle V2 is observed.

(b) The control center Z1 controls the target vehicle V2 to decelerate to 20 m/s at a rate of −2 m/s after the automated vehicle V1 follows the target vehicle V2 stably for at least 3 s, and in this case, whether the automated vehicle V1 can adjust its speed to stably follow the target vehicle V2 and does not collide with the target vehicle V2 is observed.

(c) The control center Z1 controls the target vehicle V2 to brake urgently after the automated vehicle V1 follows the target vehicle V2 stably again for at least 3 s, and at this time, whether the automated vehicle V1 experiences emergency braking and does not collide with the target vehicle V2 is observed.

(4) A speed of the automated vehicle V1 is obtained in real time by the speed sensor on the automated vehicle V1, and transmitted to the control center Z1. A distance between the automated vehicle V1 and the target vehicle V2 and a motion video of the target vehicle V2 are obtained in real time by the binocular camera, and then transmitted to the control center Z1. A speed of the target vehicle V2 is obtained in real time by the on-board device and transmitted to the control center Z1.

(5) The cooperative driving capability of the automated vehicle V1 is determined by the control center Z1 according to the received speed of the automated vehicle V1, the distance between the automated vehicle V1 and the target vehicle V2 and the speed of the target vehicle V2.

The cooperative driving capability of the automated vehicle V1 is specifically determined as follows.

In case (a) of step (3), when the speed of the automated vehicle V1 obtained by the speed sensor in real time is less than the initial speed 35 km/h, and the automated vehicle V1 follows the target vehicle V2 stably at a distance greater than or equal to 10 m, the cooperative driving capability of the automated vehicle V1 is considered qualified; otherwise, unqualified.

In case (b) of step (3), when a difference between the speed of the automated vehicle V1 obtained by the speed sensor in real time and the speed of the target vehicle V2 (20 m/s) is within the error range (−5 to 5 km/h), and the automated vehicle V1 follows the target vehicle V2 stably at a distance greater than or equal to 10 m, the cooperative driving capability of the automated vehicle V1 is considered qualified; otherwise, unqualified.

In case (c) of step (3), when the speed of the automated vehicle V1 is reduced to 0 (that is, the automated vehicle V1 recognizes the emergency braking of the target vehicle V2), and the automated vehicle V1 maintains a following distance greater than or equal to 10 m from the target vehicle V2, the cooperative driving capability of the automated vehicle V1 is considered qualified; otherwise, unqualified.

In the cooperative straight-line driving of the automated vehicle V1, the position and speed of the vehicle ahead in the same lane are detected by the equipped sensing device, and based on the detected data, an appropriate response is made to achieve the stable following. The operation ability of the automated vehicle is reflected in that it can detect the position and speed of other vehicles in the main lane, and adaptively adjust its own speed on the premise of safety to achieve the stable following driving and avoid collision with the vehicles ahead.

The control center Z1 displays the test and evaluation result of the automated vehicle V1. When the following requirements are met, the automated vehicle V1 will be considered to pass the test: (a) the automated vehicle V1 starts to adjust its speed to prepare for the stable following driving when approaching the target vehicle (that is, a distance between the automated vehicle V1 and the target vehicle is the preset following distance); (b) when recognizing the deceleration of the target vehicle V2, the automated vehicle V1 adjusts its speed according to the speed and the position of the target vehicle V2 to achieve the stable following driving and avoid collision with the target vehicle V2; (c) when recognizing the emergency braking of the target vehicle V2, the automated vehicle V1 brakes quickly and does not collide with the target vehicle V2.

### Embodiment 2

As shown in FIG. 2, the method of this disclosure for testing cooperative driving capability of an automated vehicle is used to test the cooperative driving capability of the automated vehicle to decelerate and avoid collisions when the vehicle in front of the adjacent lane drives in on a straight road. The road includes at least two straight lanes (a first lane B1 and a second lane B2), and the line between the first lane B1 and the second lane B2 is a white dotted line. The automated vehicle is labeled as V1; a target vehicle is labeled as V2; a control center is labeled as Z1; a starting point is labeled as L1; and an end point is labeled as L2. The method is specifically described as follows.

(1) The automated vehicle V1 is driven by the safety officer to the starting point L1 of the first lane B1 in a manual driving mode, and parked. A following distance is preset by the control center Z1 to be 10 m.

(2) The target vehicle V2 is controlled by the control center Z1 to travel to a position in front of the automated vehicle V1 in the adjacent lane, where a distance between the position and the automated vehicle V1 is 50 m.

(3) The safety officer sends a test request to the control center Z1, and the control center Z1 sends a driving instruction to the automated vehicle V1 according to the received test request. The safety officer starts an automatic driving mode of the automated vehicle V1 according to the driving instruction. The automated vehicle V1 starts from the test starting point and enters the test scenario. The automated vehicle V1 is accelerated to 35 km/h on the first lane B1 , and then approaches the target vehicle V2 along the middle of the lane at a constant speed. At the same time, the control center Z1 controls the target vehicle V2 to accelerate to (30±2) km/h (minimum speed for straight travelling) and then travel straightly along the second lane B2.

When the distance between the automated vehicle V1 and the target vehicle V2 reaches 10 m, the control center controls the target vehicle V2 to turn on the turn signal, and the target vehicle V2 starts to turn into the first lane B1 after at least 3 s. Whether the automated vehicle V1 can adjust its speed to stably follow the target vehicle V2 and does not collide with the target vehicle V2 is observed.

(4) A speed of the automated vehicle is obtained in real time by the speed sensor on the automated vehicle V1, and transmitted to the control center Z1. A distance between the automated vehicle V1 and the target vehicle V2 and a motion video of the target vehicle V2 are obtained in real time by the binocular camera, and then transmitted to the control center Z1. A speed of the target vehicle V2 is obtained in real time by the on-board device and transmitted to the control center Z1.

(5) The cooperative driving capability of the automated vehicle V1 is determined by the control center Z1 according to the received speed of the automated vehicle V1, the distance between the automated vehicle V1 and the target vehicle V2 and the speed of the target vehicle V2.

The cooperative driving capability of the automated vehicle is specifically determined as follows.

When the speed of the automated vehicle V1 obtained by the speed sensor in real time is less than the initial speed 35 km/h, and the automated vehicle V1 follows the target vehicle V2 stably at a distance greater than or equal to 10 m, the cooperative driving capability of the automated vehicle is considered qualified; otherwise, unqualified.

When the target vehicle V2 ahead of the automated vehicle V1 travels into the lane where the automated vehicle V1 travels, the automated vehicle V1 can make an appropriate response according to the information of the target vehicle V2 sensed by the equipped sensing device, avoiding a collision with the target vehicle V2. The operation ability of the automated vehicle is reflected in that it can detect the position and speed information of vehicles in the adjacent lane, and can adaptively adjust its own speed to avoid collision with the vehicles ahead that travel into the same lane.

The control center Z1 displays the test and evaluation result of the automated vehicle V1. When the following requirements are met, the automated vehicle V1 will be considered to pass the test: (a) the automated vehicle V1 reduces its speed and does not collide with the target vehicle V2 ahead when the binocular camera recognizes that the target vehicle V1 turns on the turn signal and is ready to travel into the same lane.

### Embodiment 3

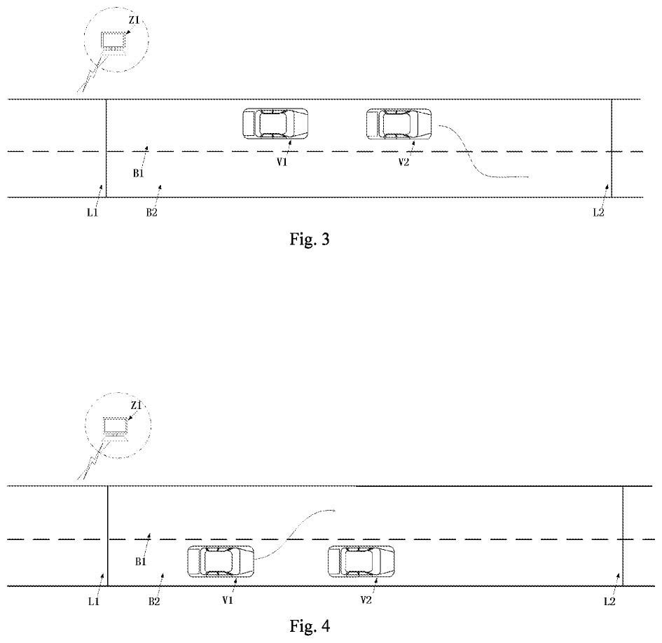

As shown in FIG. 3, the method of this disclosure for testing cooperative driving capability of an automated vehicle is used to test the ability of automated vehicles to recognize and drive stably when the vehicle ahead in the same lane drives out on a straight road. The road includes at least two straight lanes (a first lane B1 and a second lane B2), and the line between the first lane B1 and the second lane B2 is a dotted line. The automated vehicle is labeled as V1; a target vehicle is labeled as V2; a control center is labeled as Z1; a starting point is labeled as L1; and an end point is labeled as L2. The method is specifically described as follows.

(1) The automated vehicle V1 is driven by the safety officer to the starting point L1 of the first lane B1 in manual driving mode, and parked. A following distance is preset by the control center Z1 to be 10 m.

(2) The target vehicle V2 is controlled by the control center Z1 to travel to a position in front of the automated vehicle V1 in the same lane, where a distance between the position and the automated vehicle V1 is 50 m.

(3) The safety officer sends a test request to the control center Z1, and the control center Z1 sends a driving instruction to the automated vehicle V1 according to the received test request. The safety officer starts an automatic driving mode of the automated vehicle V1 according to the received driving instruction, and the automated vehicle V1 starts from the test starting point and enters the test scenario. The automated vehicle V1 is accelerated to 35 km/h on the first lane B1, and then approaches the target vehicle V2 along the middle of the lane at a constant speed. At the same time, the control center Z1 controls the target vehicle V2 to accelerate to (30±2) km/h (minimum speed for straight travelling) and then travel straightly along the first lane B1.

(a) When a distance between the automated vehicle V1 and the target vehicle V2 reaches the preset following distance, whether the automated vehicle V1 can adjust its speed to stably follow the target vehicle V2 is observed.

(b) The control center Z1 controls the target vehicle V2 to turn on the turn signal and turn into the second lane B2 at least 3 s later after the automated vehicle V1 follows the target vehicle V2 stably for at least 3 s, and at this time, whether the automated vehicle V1 can keep running in a straight line, and whether the automated vehicle V1 experiences great changes in the speed greatly and does not collide with the target vehicle V2 are observed.

(4) The speed sensor on the automated vehicle V1 obtains a speed of the automated vehicle V1 in real time, and transmits the obtained speed to the control center Z1. The binocular camera obtains a distance between the automated vehicle V1 and the target vehicle V2 and a motion video of the target vehicle V2 in real time, and transmits the distance and the motion video to the control center Z1. The on-board device obtains a speed of the target vehicle V2 in real time and transmits the speed of the target vehicle V2 to the control center Z1.

(5) The control center Z1 determines the cooperative driving capability of the automated vehicle according to the received speed of the automated vehicle V1, the distance between the automated vehicle V1 and the target vehicle V2, and the speed of the target vehicle V2.

The cooperative driving capability of the automated vehicle V1 is specifically determined as follows.

In case (a) of step (3), when the speed of the automated vehicle V1 obtained by the speed sensor in real time is less than the initial speed 35 km/h, and the automated vehicle V1 follows the target vehicle V2 stably at a distance greater than or equal to 10 m, the cooperative driving capability of the automated vehicle V1 is considered qualified; otherwise, unqualified.

In case (b) of step (3), when the speed of the automated vehicle V1 obtained by the speed sensor in real time has no significant change, and the automated vehicle V1 continues to travel in a straight line without collision with the target vehicle V2, the cooperative driving capability of the automated vehicle is considered qualified; otherwise, unqualified.

In the process of avoiding the target vehicle V2 which travels out of the lane of the automated vehicle V1, the automated vehicle V1 can make an appropriate response based on the information of the target vehicle V2 detected by the equipped sensing device, avoiding experiencing great changes in the speed. The operation ability of the automated vehicle is reflected in that it can detect the position and speed information of other vehicles in the adjacent lane; avoid great change in the speed when the target vehicle V2 leaves the lane of the automated vehicle V1; and keep the stable straight-line driving after the target vehicle leaves.

The control center Z1 displays the test and evaluation result of the automated vehicle V1. When the following requirements are met, the automated vehicle V1 will be considered to pass the test: (a) when a distance between the automated vehicle V1 and the target vehicle V2 reaches the preset following distance, the automated vehicle V1 can adjust its speed to realize the stable following; (b) after the automated vehicle V1 stably follows the target vehicle V2 for at least 3 s, when the target vehicle V2 is controlled to drive out of the lane of the automated vehicle V1, the fluctuation in the speed of the automated vehicle V1 is not more than 5 km/h.

### Embodiment 4

As shown in FIG. 4, the method of this disclosure for testing cooperative driving capability of an automated vehicle is used to test the ability of automated vehicles to change lanes and overtake when the automated vehicle V1 has a speed conflict with the vehicle ahead in the same lane. The road includes at least two straight lanes (a first lane B1 and a second lane B2), and the line between the first lane B1 and the second lane B2 is a dotted line. The automated vehicle is labeled as V1; a target vehicle is labeled as V2; a control center is labeled as Z1; a starting point is labeled as L1; and an end point is labeled as L2. The method is specifically described as follows.

(1) The automated vehicle V1 is driven by the safety officer to the starting point L1 of the first lane B1 in manual driving mode, and parked. A following distance is preset by the control center Z1 to be 10 m.

(2) The target vehicle V2 is controlled by the control center Z1 to travel to a position in front of the automated vehicle V1 in the same lane, where a distance between the position and the automated vehicle V1 is 50 m.

(3) The safety officer sends a test request to the control center Z1, and the control center Z1 sends a driving instruction to the automated vehicle V1 according to the received test request. The safety officer starts an automatic driving mode of the automated vehicle V1 according to the received driving instruction, and the automated vehicle V1 starts from the test starting point and enters the test scenario. The automated vehicle V1 is accelerated to 35 km/h on the second lane B2, and then approaches the target vehicle V2 along the middle of the lane at a constant speed. At the same time, the control center Z1 controls the target vehicle V2 to accelerate to (10±2) km/h (minimum speed for straight travelling) and travel straightly along the second lane B2.

When a distance between the automated vehicle V1 and the target vehicle V2 reaches the preset following distance (10 m), whether the automated vehicle V1 can adjust its speed and turn to change lane (the steering angle and direction can be obtained through the steering angle sensor installed on the automated vehicle V1) to avoid the target vehicle V2 is observed.

(4) A speed of the automated vehicle V1 is obtained in real time by the speed sensor thereon, and transmitted to the control center Z1. A distance between the automated vehicle V1 and the target vehicle V2 and a motion video of the target vehicle V2 are obtained in real time by the binocular camera, and then transmitted to the control center Z1. A speed of the target vehicle V2 is obtained in real time by the on-board device and transmitted to the control center Z1.

(5) The cooperative driving capability of the automated vehicle V1 is determined by the control center Z1 according to the received speed of the automated vehicle V1, the distance between the automated vehicle V1 and the target vehicle V2, and the speed of the target vehicle V2.

The cooperative driving capability of the automated vehicle V1 is specifically determined as follows.

In the case that the speed of the target vehicle V2 is lower than the lower speed limit of the lane, when the automated vehicle V1 starts to turn into the first lane B1 at least 3 s after the turn signal is turned on; overtakes to avoid the target vehicle V2; or does not continue following the target vehicle V2 to avoid colliding with the target vehicle V2, the cooperative driving capability of the automated vehicle V1 is considered qualified; otherwise, unqualified.

The automated vehicle V1 can obtain the information of the vehicles ahead travelling at a low rate through the equipped sensing device during the straight travelling, so it can overtake the target vehicle V2 or stop following the target vehicle V2 to avoid colliding with the target vehicle V2. The operation ability of the automated vehicle V1 is reflected in that it can detect the speed of the vehicles ahead in the same lane, and can adaptively adjust its own speed and direction to overtake the vehicle ahead according to the speed limit of the lane.

The control center Z1 displays the test and evaluation result of the automated vehicle V1. When the following requirements are met, the automated vehicle V1 will be considered to pass the test: (a) when a distance between the automated vehicle V1 and the target vehicle V2 reaches the preset following distance, the automated vehicle V1 overtakes to avoid the slow-travelling target vehicle V2; and (b) the automated vehicle V1 does not follow the target vehicle V2.

Described above are only preferred embodiments of the disclosure, and are not intended to limit the scope of the disclosure. Any changes, modifications and improvements made by those skilled in the art without departing from the spirit of the disclosure shall fall within the scope of the disclosure.

What is claimed is:

1. A system for testing cooperative driving capability of an automated vehicle, comprising:
the automated vehicle;
a target vehicle;
a test road; and
a control center;
wherein the automated vehicle and the target vehicle are located on the test road, and the control center is located beside the test road;
a speed sensor and a binocular camera are provided on the automated vehicle;
and the speed sensor and the binocular camera are connected to the control center through a wireless communication device, respectively;
the target vehicle is a simulation vehicle for testing, and an on-board device is provided on the target vehicle; and the on-board device is connected to the control center through the wireless communication device.

2. The system of claim 1, wherein the speed sensor is configured to obtain a speed of the automated vehicle and transmit the speed of the automated vehicle to the control center;
the binocular camera is configured to acquire a distance between the automated vehicle and the target vehicle and a motion video of the target vehicle, and transmit the distance between the automated vehicle and the target vehicle and the motion video of the target vehicle to the control center; and
the on-board device is configured to obtain a speed of the target vehicle and transmit the speed of the target vehicle to the control center.

3. The system of claim 2, wherein the control center is configured to receive the speed of the automated vehicle, the distance between the automated vehicle and the target vehicle, the motion video of the target vehicle, and the speed of the target vehicle, determine a cooperative driving capability of the automated vehicle and send driving instructions to the automated vehicle and the target vehicle.

4. The system of claim 1, wherein the wireless communication device has a V2X communication protocol.

5. The system of claim 1, further comprising:
a safety officer;
wherein the safety officer is configured to drive the automated vehicle to a starting point of the test road in manual driving mode, and then switch the manual driving mode to automatic driving mode after the automated vehicle is stopped, and the safety officer is further configured to send driving instructions to the target vehicle through the control center.

6. A method for testing cooperative driving capability of an automated vehicle, comprising:
(1) driving, by a safety officer, an automated vehicle to a starting point of a test road in manual driving mode, and parking the automated vehicle;
(2) controlling, by a control center, a target vehicle to travel to a position in front of the automated vehicle in the same lane, wherein the position is away from the automated vehicle at a safe distance;
(3) sending, by the safety officer, a test request to the control center; sending, by the control center, a driving instruction to the automated vehicle according to the received test request; starting, by the safety officer, an automatic driving mode of the automated vehicle according to the driving instruction received by the automated vehicle; and at the same time, controlling, by the control center, the target vehicle to travel at a preset speed and route;
(4) obtaining, by the speed sensor on the automated vehicle, a speed of the automated vehicle in real time, and transmitting, by a wireless communication device, the obtained speed of the automated vehicle to the control center; obtaining, by a binocular camera, a distance between the automated vehicle and the target vehicle and a motion video of the target vehicle in real time, and transmitting, by the wireless communication device, the distance between the automated vehicle and the target vehicle and the motion video of the target vehicle to the control center; obtaining, by an on-board device on the target vehicle, a speed of the target vehicle in real time; and transmitting, by the wireless communication device, the speed of the target vehicle to the control center; and
(5) determining, by the control center, the cooperative driving capability of the automated vehicle according to the speed of the automated vehicle, the distance between the automated vehicle and the target vehicle and the speed of the target vehicle.

7. The method of claim 6, wherein in step (2), the safe distance is 50 m.

8. The method of claim 6, wherein in step (5), the cooperative driving capability of the automated vehicle is determined as follows:
if the distance between the automated vehicle and the target vehicle is greater than or equal to a preset following distance, and a difference between the speed of the automated vehicle and the speed of the target vehicle is within an error range, the cooperative driving capability of the automated vehicle is considered qualified;
otherwise, unqualified.

9. The method of claim 8, wherein the preset following distance is 10 m, and the error range is from −5 to 5 km/h.
